(19) United States
(12) Patent Application Publication
(10) Pub. No.: US 2007/0076295 A1
(43) Pub. Date: Apr. 5, 2007

(54) Electronic adjustable color filter

(75) Inventors: Bing Wen, Camarillo, CA (US); Bruce K. Winker, Ventura, CA (US)

Correspondence Address: KUTAK ROCK LLC, 1801 CALIFORNIA STREET, SUITE 3100, DENVER, CO, 80202-2626, US

(73) Assignee: Rockwell Scientific Company

(21) Appl. No.: 11/240,909

(22) Filed: Sep. 30, 2005

(51) Int. Cl. G02B 5/30; G02B 5/20

(52) U.S. Cl. 359/502

(57) ABSTRACT

An electronically adjustable color filter device is provided for filtering light at a wavelength corresponding to a selected color of the Electromagnetic Spectrum. Unpolarized light, at the specified wavelength, is polarized using a dichroic, cholesteric polarizer. An adjustable wave plate is optically aligned with the polarizer to convert the polarized light into two separate elements, each element having a different polarization state. A color filter, which may be a dichroic cholesteric film, filters one element of the polarized light while permitting the second element to pass. A plurality of the color filter devices may be positioned sequentially to filter various colors of light, thereby producing light having a desired combination of colors. Polarized light may be filtered, whereby a polarizer is not required. An electronically adjustable color filter system may include multiple filter devices, as well as a color detector and a controller for adjusting the wave plates.

### FIELD OF THE INVENTION

This invention relates generally to color filters. More particularly, this invention relates to an electronically adjustable color filter capable of producing a plethora of color light combinations using either polarized or unpolarized, broadband white light.

### BACKGROUND

Color lighting systems are found in a variety of entertainment facilities, to include theaters, auditoriums, concert halls and stadiums. Regardless the size of the venue, in almost all instances a color lighting system is required or desired. The quality of the entertainment provided is often dependent, in part, on the quality of the color lighting system.

Aside from professional and amateur entertainment venues, theme parks and other such attractions use color light to enhance the experience of their customers. Private and public facilities, such as churches and museums, also have a need for variable color lighting. Further, sales oriented facilities and events, to include shopping malls and trade shows, rely on color lighting to help market products. It is simply a fact of life that color lighting is part of almost every person's daily routine.

Typically, color light systems include a broad band, white light source, the output of which must be filtered to produce the desired color(s) of light. In many instances, color filtering includes the use of “color wheels”. Generally speaking, color wheels rely on the movement (rotation or otherwise) of color filters into and out of optical alignment with a transmitted white light. In many instances, the color filters are dichroic filters, which is to say they filter (reflect or absorb) light having one wavelength and pass through all remaining light. The filters may be glass, gelatin, or other transparent/semi-transparent materials. Often, the number of possible color combinations is limited by the number of color filters that can be mounted into the color wheel. Further, the clarity of colors is affected by filter movement, alignment, etc.

Absorption is the most prevalent means for filtering colored light. Unfortunately, absorbed light can generate significant quantities of heat which must be dissipated by the lighting system. Operational heating also limits the optical power of a system, as there is a direct correlation between optical power and absorbed heat. System cooling requirements typically require active (e.g. fans) or passive (e.g. cooling fins) cooling subsystems. In addition to heating concerns, standard color wheel systems include multiple moving, mechanical components. The process of changing colors is distracting to the audience. Also, moving parts impede or limit the response time/speed of a system, as well as reduce system reliability. In most instances, the useful operational life of a system is severely limited by reliability issues.

Pixilated color lighting systems are yet another lighting option found in the prior art. Unlike color wheel systems which are subtractive (filtering) in nature, pixilated systems are additive. Stated differently, pixilated systems achieve desired color combinations by adding colors together at a level unresolved by the naked human eye. Red, green and blue pixels produce an image on a screen, or alternatively direct color light to a designated region. Fiber optics or other delivery methods carry the colored light from light sources to the pixilated surface. Although operationally cooler, and void of multiple moving parts, pixilated systems are not without their limitations. A ⅔ decrease in light intensity results from the use of a broadband while light source and red, green and blue pixel elements. To obtain red, green and blue light from the broadband white light, the light must pass through a matrix of red, green and blue absorptive “dots”. On each dot or pixel, two of the three colors (i.e. green and blue on a red dot) are absorbed. Therefore, by converting the broadband white light to red, green, and blue, ⅔ of the light is lost in the conversion. This loss precedes any further losses associated with transmitting and mixing the light.

Hence, there is a need for a color filter and color lighting system that overcomes one or more of the limitations discussed above.

### SUMMARY

The electronic adjustable color filters and color filter system herein disclosed advance the art and overcome problems articulated above by providing a subtractive color filter employing adjustable wave plates and dichroic filter elements to selectively generate light having a desired color.

In particular, and by way of example only, in one embodiment an electronic adjustable color filter device is provided including: at least one means for selectively converting a predetermined component of polarized light into a first element having a first polarization state, and a second element having a second polarization state, wherein the first polarization state differs from the second polarization state; and at least one means for filtering, at a known wavelength corresponding to a desired color, the polarized light to permit transmission of the first element and prevent transmission of the second element.

In another embodiment, an electronic adjustable color filter device is provided, including: a wave plate positioned to selectively convert polarized light into a first element having a first polarization state and a second element having a second polarization state, the second polarization state orthogonal to the first polarization state; and a color filter positioned sequentially following the wave plate to permit transmission of the first element and prevent transmission of the second element.

In yet another embodiment, an electronic adjustable color lighting system is provided, including: a light source for generating unpolarized light; one or more polarizers optically aligned with the light source for polarizing a portion of the generated light; one or more wave plates, each wave plate positioned sequentially after a corresponding polarizer to selectively convert the polarized portion of the generated light into a first element having a first polarization state and a second element having a second polarization state, the second polarization state orthogonal to the first polarization state; one or more color filters, each color filter positioned sequentially following a corresponding wave plate to allow the transmission of the first element and prevent the transmission of the second element; and, a color detector for measuring a chromaticity of light transmitted from the system.

In still yet another embodiment, a method for providing color light is provided, including: receiving unpolarized light; polarizing at least a portion of the received light; selectively converting the polarized portion of the received light into a first element having a first polarization state and a second element having a second polarization state, the second polarization state orthogonal to the first polarization state; and, filtering the polarized portion of the received light at a predetermined wavelength to allow transmission of the first element and prevent transmission of the second element.

### BRIEF DESCRIPTION OF THE DRAWINGS

FIG. 1 is perspective view of a single color electronic adjustable color filter, according to an embodiment;

FIG. 2 is a perspective view of a multi-color electronic adjustable color filter for receiving unpolarized light, according to an embodiment;

FIG. 3 is a perspective view of a multi-color electronic adjustable color filter for receiving polarized light, according to an embodiment; and

FIG. 4 is a schematic of an electronic adjustable color lighting system, according to an embodiment.

### DETAILED DESCRIPTION

Before proceeding with the detailed description, it should be noted that the present teaching is by way of example, not by limitation. The concepts herein are not limited to use or application with one specific type of electronic adjustable color filter device in a specific environment. Thus, although the instrumentalities described herein are for the convenience of explanation, shown and described with respect to exemplary embodiments, the principles herein may be equally applied in other types of electronic adjustable color filter devices in a variety of different environments.

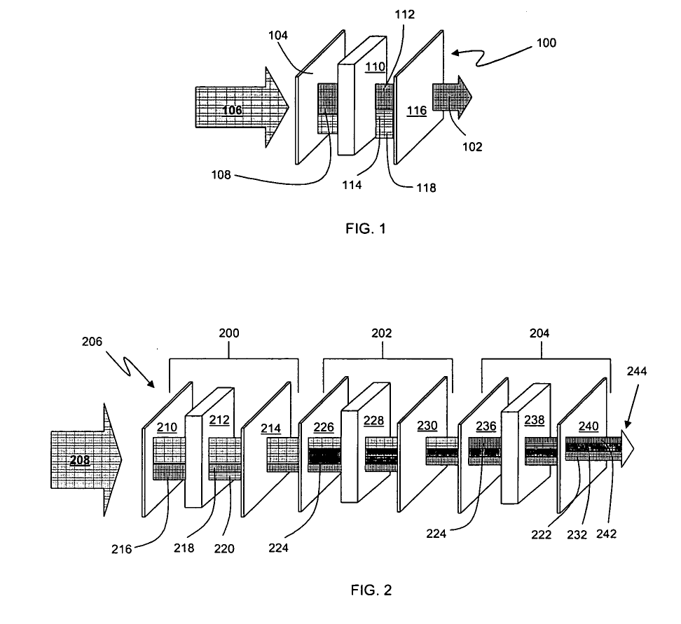

FIG. 1 illustrates an electronic adjustable color filter device 100 according to the present disclosure. Filter device 100 is a single color filter device 100, which is to say the contribution of a single color (e.g. red) to the overall color of a transmitted light 102 is controlled by filter device 100. As shown, a dichroic polarizer 104 is optically aligned with incoming, unpolarized light 106. Unpolarized light refers to electromagnetic radiation in which there are equal amounts of two orthogonal (i.e. left-hand circular and right-hand circular, or horizontal linear and vertical linear) polarization states that have no fixed phase relationship between them. Dichroic polarizer 104 is selected to polarize all of the incoming broadband, white light 106 having a predetermined wavelength. The predetermined wavelength corresponds to the wavelength of the single color, which is a wavelength of light in the visible range of the Electromagnetic Spectrum (the “EM Spectrum”). If, for example, filter 100 is intended to filter and control the color red, the wavelength of concern would be in the range of approximately 622-780 nanometers. If the color to filter is blue, the wavelength would be in the range of approximately 455-492 nanometers, and if it is green, the wavelength would be approximately 492-577 nanometers.

In one embodiment, dichroic polarizer 104 is a circular polarizer, and may be either a left-hand or right-hand polarizer. In yet another embodiment, dichroic polarizer 104 may be a linear polarizer. Further, dichroic polarizer 104 may be a cholesteric film. A cholesteric film is a liquid crystal film with a helical structure. Such a film will reflect left-hand or right-hand light (determined by the “handness” of the helical structure) within a certain wavelength range (determined by the “pitch” of the helical structure). Light 106 passing through polarizer 104 will become polarized, for example left-hand polarized, as only the left-hand polarized component 108 of light 106 will be allowed to pass. The right-hand polarized component (not shown) of light 106 will be reflected. It can be appreciated that reflection of one polarization of unpolarized light 106 may result in a reduced intensity of light 106 by at least 50%.

Positioned sequentially to follow dichroic polarizer 104 is a liquid crystal wave plate 110. Wave plate 110 may be electronically tuned or adjusted to convert the polarized component 108 of light 106 into two distinct elements. A first element 112 maintains the polarization state induced by dichroic polarizer 104, e.g. left-hand polarization. A second element 114, however, has a polarization state (e.g. a right-hand polarization) which differs from the polarization state of element 112. In at least one embodiment, the polarization state of element 114 is orthogonal to the polarization state of element 112. The percentage of polarized component 108 converted to a second polarization state (e.g. the right-hand polarization of element 114) may be controlled by adjusting the voltage applied to wave plate 110.

A dichroic polarizer 116 is optically aligned with wave plate 110. In particular, dichroic polarizer 116 is positioned sequentially to follow wave plate 110. Dichroic polarizer 116 receives the polarized elements 112, 114 of light 106, as well as the unpolarized light 118. Of note, unpolarized light 118 comprises those wavelengths of light (e.g. blue and green light) not polarized by dichroic polarizer 104. Similar to dichroic polarizer 104, dichroic polarizer 116 filters light with a predetermined wavelength and polarization. In at least one embodiment, color filter 116 is a cholesteric film. Dichroic polarizer 104 and dichroic polarizer 116 are matched to ensure that both act upon light at the same single, predetermined wavelength.

In operation, dichroic polarizer 116 permits light having one polarization state, e.g. the left-hand polarization of element 112, to pass through the dichroic polarizer 116, while reflecting (or absorbing) light having a second polarization state, e.g. the right-hand polarization of element 114. In this manner, the amount of transmitted light 102 within a predetermined wavelength range (e.g. the wavelength range corresponding to the color red) is controlled. Hence, the color of transmitted light 102 is controlled, and may be adjusted by color filter device 100.

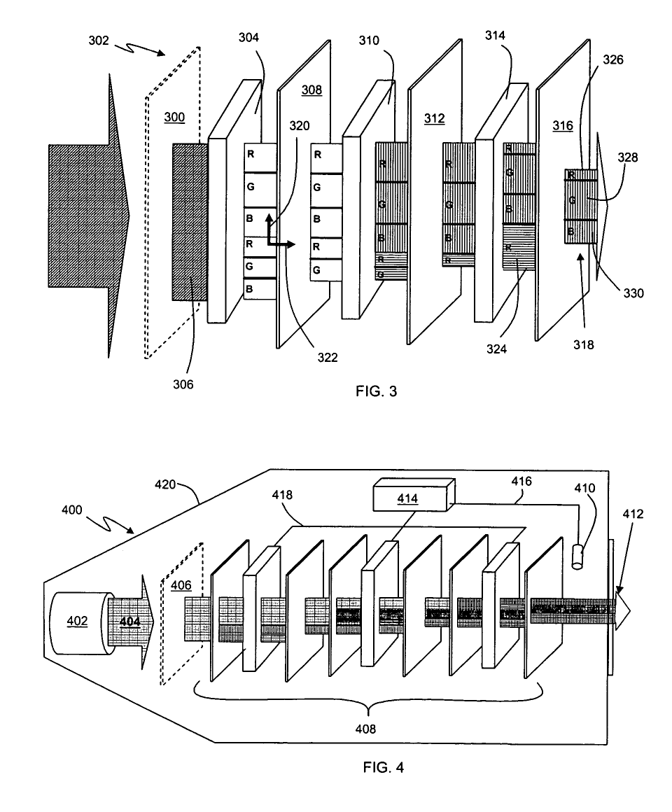

Referring now to FIG. 2, a plurality of single color (i.e. single wavelength) filter devices, of which color filter devices 200, 202 and 204 are exemplary, may be optically aligned to form a multi-color filter device 206. In one embodiment, multi-color filter device 206 may comprise color filter devices 200-204 for filtering blue, green and red light respectively. In combination with filter devices 200-204, a color enhancing filter 300 (FIG. 3) may be used to enhance color saturation. Typically, the colors yellow and cyan, found at the boundaries of red, green and blue (“RGB”) in the EM Spectrum, cannot be efficiently controlled by R, G, B filters. Color enhancing filter 300 is a double-notch filter used to block the periphery of the R,G,B portion of the EM Spectrum (i.e. colors in the region of yellow and cyan), thereby increasing the efficiency of the filter device 206. In yet another embodiment, multi-color filter device 206 may include, in addition to blue, green and red color filter devices 200-204, color filter devices (not shown) for yellow and cyan light. In this instance, a color enhancing filter, such as filter 300, is not required.

In the operation of multi-color filter device 206, unpolarized, broadband white light 208 is received by multi-color filter device 206. The unpolarized light 208 strikes the first of several single color filter devices 200. As discussed in detail above, filter device 200 comprises a dichroic polarizer 210, an electronically tunable or adjustable wave plate 212, and a dichroic polarizer 214. A portion 216 of light 208, corresponding for example to the color blue in the EM Spectrum, is polarized with either a left or right hand polarization, or alternatively, with either an “x” or “y” linear polarization. Wave plate 212 converts polarized portion 216 into a first element 218 having the original polarization state, and a second element 220 having a polarization state orthogonal to the original polarization state. Dichroic polarizer 214 reflects element 220 and permits element 218 to pass through dichroic polarizer 214.

In this way, the amount of blue light 222 ultimately transmitted by multi-color filter device 206 is controlled, and is substantially equal to the amount of blue light represented by element 218. It can be appreciated that the percentage of “blue” light 222 transmitted may be changed by applying a different voltage to wave plate 212. As shown in FIG. 2, “blue” light element 218, and the remaining portion of unpolarized light, pass on to the second single wavelength, single color filter device 202.

A filtering process, similar to that disclosed above, may be used to filter green light (e.g. filter 202), as well as red light (e.g. filter 204). Specifically, a second portion 224 of incoming light 208, corresponding to the wavelength of green light, is polarized by polarizer 226, converted or modified by wave plate 228, and filtered by dichroic polarizer 230. The net result of this process is an element 232 of transmitted green light. Similarly, a portion 234 of light 208, corresponding to the wavelength of red light, is polarized by polarizer 236, converted by wave plate 238, and filtered by dichroic polarizer 240. As with the blue and the green light, an element of red light 242 is ultimately transmitted by multi-color filter device 206. The net result of using filter devices 200-204 to modify and filter unpolarized light 208 is a transmitted, color light 244 which is a combination, in whole or in part, of blue, green and red light. The percentage of each color can be tailored by electronically adjusting wave plates 212, 228, and 238, i.e. adjusting the voltage applied to each wave plate.

The disclosure thus far has focused on filtering received light which is unpolarized. In certain instances, the light received and modified to generate color light may be polarized from the outset. In this case, the number of filter components, and the sequencing of components, may be altered from that disclosed above. Referring now to FIG. 3, a multi-color filter device 302 for polarized light is presented. As discussed above, multi-color filter device 302 may include a color enhancing filter 300 (shown in phantom). Further, if the light incident upon device 302 is initially unpolarized, a polarizing filter with a polarization recycling device (not shown) may be used to convert unpolarized light into polarized light.

An electronically tunable or adjustable wave plate 304 is positioned to receive polarized, broadband white light 306, which may have been enhanced by color enhancing filter 300. Wave plate 304 is positioned to convert some or all of the light incident on wave plate 304 into two distinct polarization elements. Wave plate 304 is also optically aligned with, and positioned in front of, a dichroic polarizer 308. In at least one embodiment, dichroic polarizer 308 is a cholesteric, dichroic filter designed to filter light having a predetermined wavelength and polarization, the wavelength corresponding to a color or color range of the EM Spectrum. A second wave plate 310, substantially identical to wave plate 304, is optically aligned with, and positioned subsequent to, dichroic polarizer 308. Wave plate 310 is also used to convert incident light into two separate and distinct polarization elements, one of which is reflected by a second dichroic polarizer 312, while the remaining light passes through the filter 312. As shown in FIG. 3, dichroic polarizer 312 is positioned subsequent to wave plate 310, to filter light having a wavelength different than the light filtered by color filter 308. The sequence of an electronically adjustable wave plate followed by a cholesteric, dichroic color filter is repeated a third time, with wave plate 314 and dichroic polarizer 316 comprising the final elements of the three-color filter device 302. It can be appreciated that additional wave plate—dichroic polarizer combinations could be used to filter other colors, for example yellow and cyan.

By applying a known voltage to one or more of the adjustable wave plates 304, 310, 314, the color of the light 318 ultimately exiting multi-color filter device 302 can be modified to create substantially any of the colors of the EM Spectrum. Only one, of any number of possible operational scenarios, is depicted in FIG. 3. As shown, various amounts of blue, green and red light are sequentially discarded (reflected) by multi-color filter device 302. The amount of light in each color band discarded by the corresponding color filter (e.g. filters 308, 312, 316) is dictated by the wave plates, and in particular by the amount of light each wave plate converts to a second (e.g. orthogonal) polarization state. The conversion to a second polarization state, in turn, is dictated by the amount of voltage applied to a given wave plate. Each wave plate may be addressed and adjusted individually, and is therefore considered electronically independent. The amount of light converted by a given wave plate, however, is dependent in part on the operation of the other wave plates in the device 302. The end result of the filtering process is light having a pre-selected color, or stated differently, a combination of colors which in the case of FIG. 3 includes the colors blue, green and red.

Considering now the operation of the multi-color filter 302 in greater detail, wave plate 304 converts the polarization of incoming light 306 into a first and second polarization state, as represented by arrows 320 and 322 respectively. Dichroic polarizer 308 reflects polarized light having: (a) a wavelength corresponding to the color blue; and (b) a polarization state as represented by arrow 322. All other light, to include blue light having a polarization state represented by arrow 320, passes through dichroic polarizer 308 unaffected by polarizer 308. In this way, the amount of blue light is established and controlled.

A similar sequence of events occurs as the remaining light strikes wave plate 310. Wave plate 310 can “undo” the effects of wave plate 304, and establish new polarization states for the remaining light. As shown, the percentage of light having one polarization state or another (as indicated by the arrows 320, 322) can change according to the current applied to a given wave plate, e.g. wave plate 310. Dichroic polarizer 312, which may be, for example, a green dichroic polarizer, reflects light having: (a) a wavelength corresponding to the color green; and (b) a polarization state represented by arrow 322, and permits all other light to pass. As such, the light passing from filter 312 has both a blue and a green component that have been selectively tailored.

Finally, wave plate 314 once again establishes the percentages of polarized light having a first (arrow 320) and a second (arrow 322) polarization state. As shown in FIG. 3, a significant element 324 of the light passing through wave plate 314 has a polarization state represented by arrow 322. When the light passing through wave plate 314 strikes dichroic polarizer 316, which may be a red dichroic polarizer, the significant element 324 of red light is reflected. The result of this tailoring or adjusting of the remaining light is a transmitted light 318 having a relatively small red component 326, and much larger components of green 328 and blue 330 light.

Referring now FIG. 4, an electronic adjustable color lighting system 400 is presented. System 400 may include a broadband, white light source 402 generating polarized, or in the case of FIG. 4, unpolarized light 404. A color enhancement filter 406 (shown in phantom) may also be part of system 400.

A plurality of color filter devices 408 are optically aligned with light source 402. Color filter devices 408 may be any of several embodiments and combinations of filters, the specific details of which are encompassed in the present disclosure. A chromaticity meter or color detector 410 is oriented to measure the chromaticity of a light 412 ultimately transmitted by system 400. The chromaticity of the transmitted light 412 is communicated to a controller 414, via an electrical wire 416, for further processing and use. Alternatively, color meter 410 may simply record the characteristics of the transmitted light 412, and communicate the recorded data to controller 414, wherein the chromaticity of light 412 can be determined.

Chromaticity data is used to determine what adjustments, if any, should be made to the wave plates of the color filter devices 408. Adjustments, in the form of varying voltages selectively applied to the wave plates, are used to tune or modify the color of transmitted light 412. The electrical current applied to the wave plates is carried via electrical lines, e.g. line 418. All of the components (e.g. light source 402, color filter devices 408, etc.) may be contained in a housing 420. Alternatively, depending on the operational use of system 400, some components may be mounted outside housing 420.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure, which, as a matter of language, might be said to fall therebetween.

What is claimed is:

1. An electronic adjustable color filter device comprising:
at least one means for selectively converting a predetermined component of polarized light into a first element having a first polarization state, and a second element having a second polarization state, wherein the first polarization state differs from the second polarization state; and
at least one means for filtering, at a known wavelength corresponding to a desired color, the polarized light to permit transmission of the first element and prevent transmission of the second element.

2. The color filter device of claim 1, further comprising at least one polarizer for polarizing light received by the filter device.

3. The color filter device of claim 2, wherein the at least one polarizer is selected from the group consisting of: a blue light polarizer, a green light polarizer, a red light polarizer, a yellow light polarizer and a cyan light polarizer.

4. The color filter device of claim 2, wherein the at least one polarizer is a cholesteric film.

5. The color filter device of claim 1, wherein the at least one means for selectively converting a predetermined component of polarized light is an adjustable wave plate.

6. The color filter device of claim 1, wherein the at least one means for filtering the component of polarized light is a cholesteric filter.

7. The color filter device of claim 1, further comprising a color enhancing device positioned to enhance selected light colors received into the device.

8. The color filter device of claim 1, further comprising a color detector for measuring a chromaticity of light transmitted from the device.

9. The color filter device of claim 1, further comprising a controller for adjusting the at least one means for selectively converting a predetermined component of polarized light.

10. An electronic adjustable color filter device comprising:
a wave plate positioned to selectively convert polarized light into a first element having a first polarization state and a second element having a second polarization state, the second polarization state orthogonal to the first polarization state; and
a dichroic polarizer positioned sequentially following the wave plate to permit transmission of the first element and prevent transmission of the second element.

11. The color filter device of claim 10, further comprising a dichroic polarizer positioned sequentially prior to the wave plate for polarizing a light striking the device.

12. The color filter device of claim 11, wherein the preliminary polarizer is a cholesteric film.

13. The color filter device of claim 10, wherein the dichroic polarizer is a cholesteric color film.

14. The color filter device of claim 10, further comprising a color detector for measuring a chromaticity of light transmitted from the device.

15. The color filter device of claim 14, further comprising a controller for receiving chromaticity data from the color detector and electronically adjusting the wave plate.

16. The color filter device of claim 10, further comprising:
a plurality of wave plates positioned sequentially; and
a plurality of dichroic polarizers, each dichroic polarizer positioned sequentially following a corresponding wave plate.

17. The color filter device of claim 16, wherein the wave plates are independently adjusted.

18. The color filter device of claim 10, wherein the dichroic polarizer is selected from a group consisting of: a red filter, a blue filter, a green filter, a yellow filter and a cyan filter.

19. An electronic adjustable color lighting system comprising:
a light source for generating unpolarized light;
one or more polarizers optically aligned with the light source for polarizing a portion of the generated light;
one or more wave plates, each wave plate positioned sequentially after a corresponding polarizer to selectively convert the polarized portion of the generated light into a first element having a first polarization state and a second element having a second polarization state, the second polarization state orthogonal to the first polarization state;
one or more dichroic polarizers, each dichroic polarizer positioned sequentially following a corresponding wave plate to allow the transmission of the first element and prevent the transmission of the, second element; and
a color detector for measuring a chromaticity of light transmitted from the system.

20. The system of claim 19, further comprising a controller operable to use measured chromaticity to control the conversion of polarized light into a first and second element by one or more wave plates.

21. A method for providing color light comprising:
receiving unpolarized light;
polarizing at least a portion of the received light;
selectively converting the polarized portion of the received light into a first element having a first polarization state and a second element having a second polarization state, the second polarization state orthogonal to the first polarization state; and
filtering the polarized portion of the received light at a predetermined wavelength to allow transmission of the first element and prevent transmission of the second element.

22. The method of claim 21, wherein polarizing at least a portion of the received light further comprises directing unpolarized light through a cholesteric film.

23. The method of claim 21, wherein selectively converting the polarized portion of the received light further comprises:
directing the received light into a wave plate; and
adjusting the wave plate to convert a percentage of polarized light into the first and the second elements.

24. The method of claim 23, further comprising:
measuring a chromaticity of the provided light; and
controlling the adjustment of the wave plate.
